(19) United States
(12) Patent Application Publication
(10) Pub. No.: US 2015/0358787 A1
(43) Pub. Date: Dec. 10, 2015

(54) MESSAGE TRANSMITTING METHOD AND DEVICE

(71) Applicants: Yanni HUANG, (US); Hsin-Hsiung CHIU, (US); Gang WANG, (US); MEDIATEK SINGAPORE PTE. LTD., Singapore (SG)

(72) Inventors: Yanni HUANG, Beijing (CN); Hsin-Hsiung CHIU, Taichung City (TW); Gang WANG, Beijing (CN)

(21) Appl. No.: 14/764,680

(22) PCT Filed: Jan. 29, 2014
(86) PCT No.: PCT/CN2014/071795

§ 371 Date: Jul. 30, 2015

(30) Foreign Application Priority Data
Feb. 4, 2013 (CN) 201310042690.2

(51) Int. Cl. H04W 4/12

(52) U.S. Cl. CPC H04W 4/12

(57) ABSTRACT

A message transmitting method is provide. The method includes: determining a message-editing form according to a first determining condition; determining a path for transmitting the message according to a second determining condition; and transmitting the message according to the path.

### CROSS REFERENCE TO RELATED APPLICATIONS

The present invention is a National Stage Application of PCT Application Ser. No. PCT/CN2014/071795, filed on Jan. 29, 2014, which claims priority to Chinese Application No. CN 201310042690.2, filed on Feb. 4, 2012. The priority applications are hereby incorporated by reference in their entireties.

### BACKGROUND OF THE INVENTION

1. Field of the Invention

The disclosure generally relates to a message transmitting method and device, and more particularly, to a message transmitting method and device for determining a path for transmitting the message.

2. Description of the Related Art

IP messaging refers to Internet Protocol Messaging, which transmits messages by using the connection of the internet, rather than using the traditional operator network, so that there is no need to spend the money required by the operator, and only the cost of data traffic needs to be paid. With the ubiquity of networks and the need for rapid communication, instant messaging (IM) has developed quickly in recent years. Because using the communication medium is more convenient and cheaper than using the traditional SMS and/or MMS, there are many solutions used to integrate the IP messaging function with the traditional SMS and/or MMS applications, so that the advantages of the IM and the traditional SMS and/or MMS can be used together.

In existing solutions, due to the conversion between the traditional SMS and/or MMS and the IP messaging, a lot of complicated logic definitions are needed. Therefore, the function of the traditional SMS and/or MMS and the function of the IP messaging only can be combined in a single card mobile phone. However, due to the needs of the user, especially a user who often stays in different cities or countries, multi-card mobile phones which can start to communicate or receive calls simultaneously or non-simultaneously, have become more widely used. Therefore, in a multi-card phone, it is imperative to combine the traditional SMS and/or MMS application with the IP messaging, so that the multi-card phone can support the SMS and/or MMS applications, the IP messaging, and related functions.

### BRIEF SUMMARY OF THE INVENTION

Therefore, a message transmitting method and device are provided in the present invention to solve the problems described above.

In a preferred embodiment, the invention is directed to a message transmitting method, comprising: determining a message-editing form according to a first determining condition; determining a path for transmitting the message according to a second determining condition; and transmitting the message according to the path.

In a preferred embodiment, the invention is directed to a message transmitting device, used in a mobile device, comprising: a message-editing form determination module, determining a message-editing form according to a first determining condition; a transmitting-path determination module, determining a path for transmitting the message according to a second determining condition; and a transmission module, transmitting the message according to the path.

The message transmitting method and the message transmitting device provided in the present invention may select the best path for transmitting the information, so it is convenient for the user to use the device and it helps the user save money on phone fees.

### BRIEF DESCRIPTION OF DRAWINGS

The invention can be more fully understood by reading the subsequent detailed description and examples with references made to the accompanying drawings, wherein:

FIG. 1 is a flow diagram of determining a message-editing form according to an embodiment of the invention.

FIG. 2 is a flow diagram of selecting a path for transmitting the message according to an embodiment of the invention.

FIG. 3 is a flow diagram of selecting a path for transmitting the message according to an embodiment of the invention.

FIG. 4 is a flow diagram of determining a SIM card status to create a group according to an embodiment of the invention.

FIG. 5 is a flow diagram of informing a user to switch a SIM card and activate the IP messaging service according to an embodiment of the invention.

FIG. 6 is a flow diagram of informing a user to turn on the IP messaging service according to an embodiment of the invention.

FIG. 7 is a flow diagram of determining whether a user can join a group conversation according to an embodiment of the invention.

FIG. 8 is a flow diagram of informing the user that the group conversation is unavailable according to an embodiment of the invention.

FIG. 9 is a schematic diagram of informing the user to switch the SIM card according to an embodiment of the invention.

FIG. 10 is a schematic diagram of informing the user to turn on the IP messaging service according to an embodiment of the invention.

FIG. 11 is a schematic diagram of informing the user to join the group conversation again according to an embodiment of the invention.

FIG. 12 is a schematic diagram of the inform message illustrating that the user invites the person to activate the IP messaging service according to an embodiment of the invention.

FIG. 13 is a schematic diagram of the inform message illustrating that the user can activate the IP messaging service according to an embodiment of the invention.

FIG. 14 is a schematic diagram of the inform message illustrating that the user can switch to another SIM card according to an embodiment of the invention.

FIG. 15 is a schematic diagram of the inform message illustrating that the user can open the SIM card according to an embodiment of the invention.

FIG. 16 is a block diagram illustrating a message transmitting device according to an embodiment of the invention.

### DETAILED DESCRIPTION OF THE INVENTION

In the following embodiments of the present invention, a mobile device with dual cards is chosen as a mobile device with multi-cards in a preferred embodiment, but is not limited thereto. A mobile device with more than two subscriber identity module (SIM) cards, such as a multi-card mobile phone, can be used in the following embodiments of the present invention. A requirement of IP messaging is that the user needs to follow an activation procedure (for example, the user agrees to the terms of the IP messaging service and agrees to start using the IP messaging service) to activate the SIM card (i.e., the phone number corresponding to the SIM card is activated) as an account of the IP messaging service. When the two SIM cards in the dual-card mobile phone are activated, it represents that two accounts can be used in the mobile phone. In one embodiment of the present invention, after having an account which is activated, the user can select a message-editing form according to a first determining condition. In the present invention, the IP messaging can be an iSMS message. When the user does not activate any account or the user does not activate the SIM card (the account) to transmit a message, it will follow the procedure of processing the traditional short message service (SMS) and/or multimedia messaging service (MMS) application, and message has no difference from the general SMS and/or MMS. Therefore, the present invention can ensure convenience of use no matter whether the user activates the account.

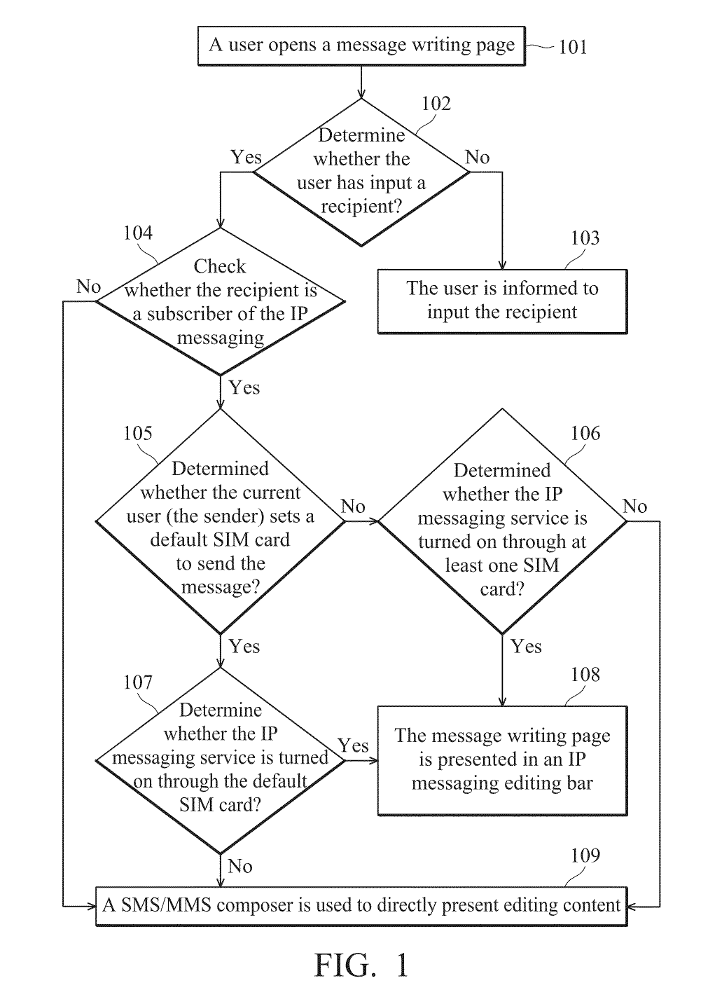

A one-on-one chat or one-to-many group chat will be described as an example to describe an embodiment of the present invention. In the one-on-one chat or one-to-many group chat, a first determining condition affecting a message-editing form comprises: whether an IP messaging service is turned on through the sender's SIM card and the IP messaging service is turned on through the recipient's SIM card. In one embodiment, after the sender selects multimedia content supported by the IP messaging service (for example, selecting photos, taking pictures, choosing videos, recording videos, selecting audios, recording audios, graffiti, sharing locations, etc.), or after the sender chooses a large expression or a dynamic expression, the message-editing form is determined. FIG. 1 is a flow diagram of determining a message-editing form according to an embodiment of the invention. As shown in FIG. 1, when a user opens a message writing page (Step 101), it is determined whether the user has input a recipient (for example, adding a single or multiple contact persons) in advance (Step 102). When the user does not input the recipient, the user is informed to input the recipient (Step 103). In one embodiment, the user can be informed to input the recipient by a dialog box popping up. In another embodiment, the user can be informed to input the recipient by a voice message or a backlight, however, the invention is not limited to other specific ways in the present invention. When it is determined that the user has input the recipient, the message transmitting device checks whether the recipient is a subscriber of the IP messaging (Step 104). When the recipient is the subscriber of the IP messaging, it is further determined whether the current user (the sender) sets a default SIM card to send the message (Step 105). When it is determined that the current user (the sender) does not set the default SIM card, it is determined whether the IP messaging service is turned on through at least one SIM card (Step 106). When it is determined that the IP messaging service is turned on in Step 106, the message writing page is presented in an IP messaging editing bar (Step 108) to allow the user to use related functions of the IP messaging. When it is determined that the current user (the sender) has set the default SIM card in Step 105, it is further determined whether the IP messaging service is turned on through the default SIM card (Step 107). When the user has set the default SIM card and the IP messaging service is not turned through the default SIM card, a SMS/MMS composer is used to directly present editing content (Step 109). When the IP messaging service is turned on through the default SIM card, the flow proceeds to Step 108 and the editing content is presented in the IP messaging editing bar. When it is determined that the IP messaging service is not turned on through any SIM card in Step 106, the flow proceeds to Step 109 and the editing content is presented through the SMS/MMS composer. In brief, when the recipient is not a subscriber of the IP messaging, the IP messaging service is not turned on through the default SIM card set by the current user (sender), or the IP messaging service is not turned on through all SIM cards of the current user (sender), the message-writing page (for example, the editing bar) is presented in the form of an SMS/MMS composer. When the recipient is the subscriber of the IP messaging and the IP messaging service is turned on through the default SIM card set by the current user (sender), or the current user (sender) does not set the default SIM card but the IP messaging service is turned on through at least one SIM card, the message-writing page (for example, the editing bar) is presented in the form of an IP messaging editing bar to allow the user (sender) to use the related functions of the IP messaging.

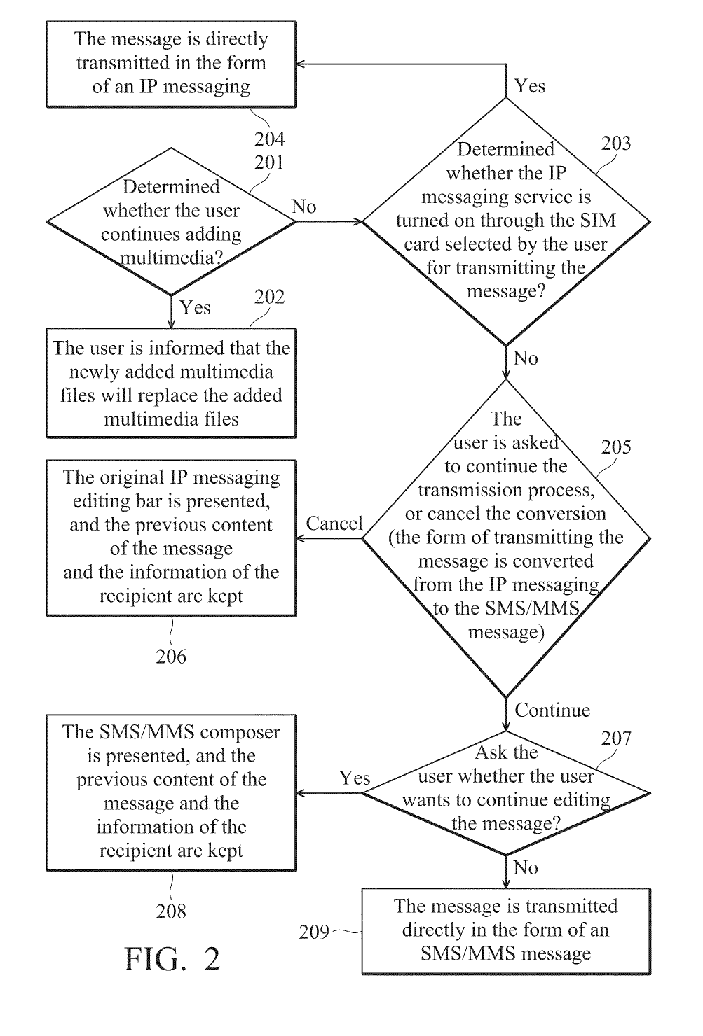

In one embodiment of the present invention, after the user determines that the editing content is presented through the IP messaging editing bar, a path for transmitting the message can be determined according to a second determining condition. In one embodiment, the second determining condition comprises the IP messaging service being turned on through the SIM card selected by the user for transmitting the message, or whether the user cancels the conversion of the IP messaging into SMS/MMS. FIG. 2 is a flow diagram of selecting a path for transmitting the message according to an embodiment of the invention. As shown in FIG. 2, after it is determined that the editing content is presented through the IP messaging editing bar in Step 108 of FIG. 1, it is determined whether the user continues adding multimedia files (Step 201). When the user continues adding multimedia files, the user is informed that the newly added multimedia files will replace the added multimedia files (Step 202). In one embodiment, the user can be informed by a dialog box popping up, but is not limited thereto. When the user stops adding multimedia files, it is further determined whether the IP messaging service is turned on through the SIM card selected by the user for transmitting the message (Step 203). When the IP messaging service is turned on through the SIM card, the message is directly transmitted in the form of an IP messaging (Step 204). When the IP messaging service is not turned on through the SIM card, the user is informed that the message is transmitted in the form of an SMS/MMS message, and the user is asked to continue the transmission process, or cancel the conversion (the form of transmitting the message is converted from the IP messaging to the SMS/MMS message) (Step 205). In one embodiment, the user can be informed by a dialog box popping up. When the user chooses to cancel the conversion, the transmission process is canceled, the original IP messaging editing bar is presented, and the previous content of the message and the information of the recipient are kept (Step 206). When the user chooses to convert the IP messaging into the SMS/MMS message, the message transmitting device further asks the user whether the user wants to continue editing the message (Step 207). When the user chooses to continue editing the message, the transmission will be canceled, the SMS/MMS composer is presented, and the previous content of the message and the information of the recipient are kept (Step 208). When the user does not continue editing the message, the message is transmitted directly in the form of an SMS/MMS message (Step 209).

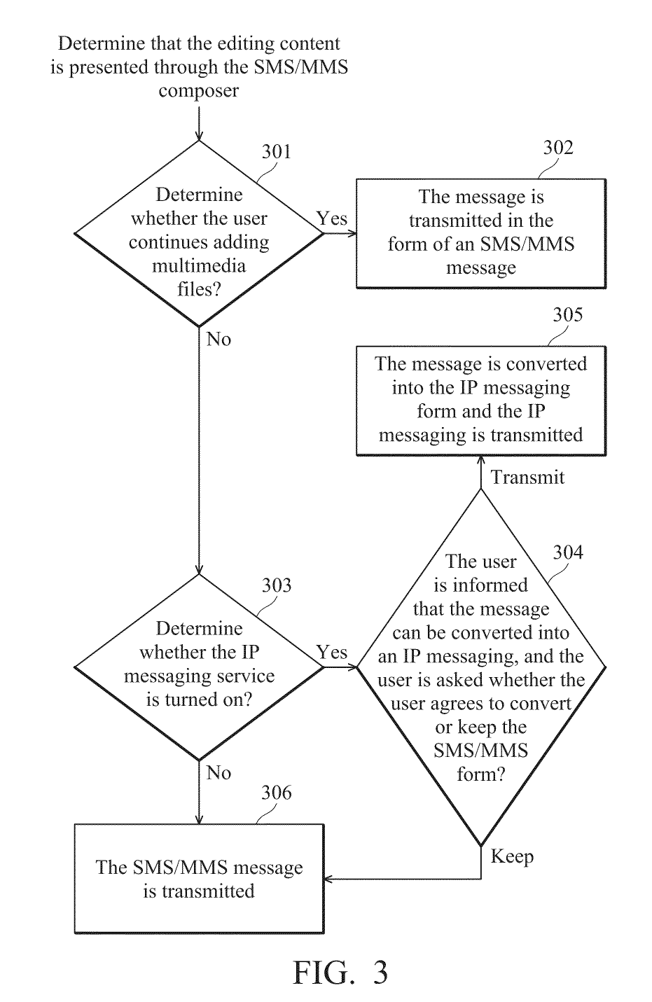

In one embodiment of the present invention, after the user determines that the editing content is presented through the SMS/MMS composer, a path for transmitting the message can be further determined according to a third determining condition. In one embodiment, the third determining condition comprises the IP messaging service is turned on through the SIM card selected by the user for transmitting the message, or whether the user cancels the conversion of the SMS/MMS into an IP messaging. FIG. 3 is a flow diagram of selecting a path for transmitting the message according to an embodiment of the invention. As shown in FIG. 3, after it is determined that the editing content is presented through the SMS/MMS composer in Step 109 of FIG. 1, it is determined whether the user continues adding multimedia files (Step 301). When the user continues adding multimedia files, the message which is added into the multimedia files is transmitted in the form of an SMS/MMS message (Step 302). When the user does not continue adding multimedia files, it is further determined whether the IP messaging service is turned on through the SIM card (such as the default SIM card or the SIM card selected by the user) selected by the user for transmitting the message (Step 303). When the IP messaging service is turned on through the SIM card, the user is informed that the message can be converted into an IP messaging to reduce the charge of the SMS/MMS, and the message transmitting device further asks the user whether the user agrees to convert or keep the SMS/MMS form (Step 304). When the user agrees to convert the form, the message is converted into the IP messaging form and the IP messaging is transmitted (Step 305). When the user keeps the SMS/MMS form, the message is kept in the SMS/MMS form, and the SMS/MMS message is transmitted (Step 306). When the IP messaging service is not turned on through the SIM card used to transmit the messages, the message is kept in the SMS/MMS form and the SMS/MMS message is transmitted (Step 306).

The present invention is based on whether the sender or the recipient activates/turns on the IP services, the content transmitted in the message and other determining conditions to automatically select the best path (the SMS, MMS, and IP messaging) for transmitting the message, so that it is convenient for the user to save on phone fees.

In one embodiment of the present invention, a group chat mode can be further processed, so that a message can be sent via the IP messaging form in the group chat mode.

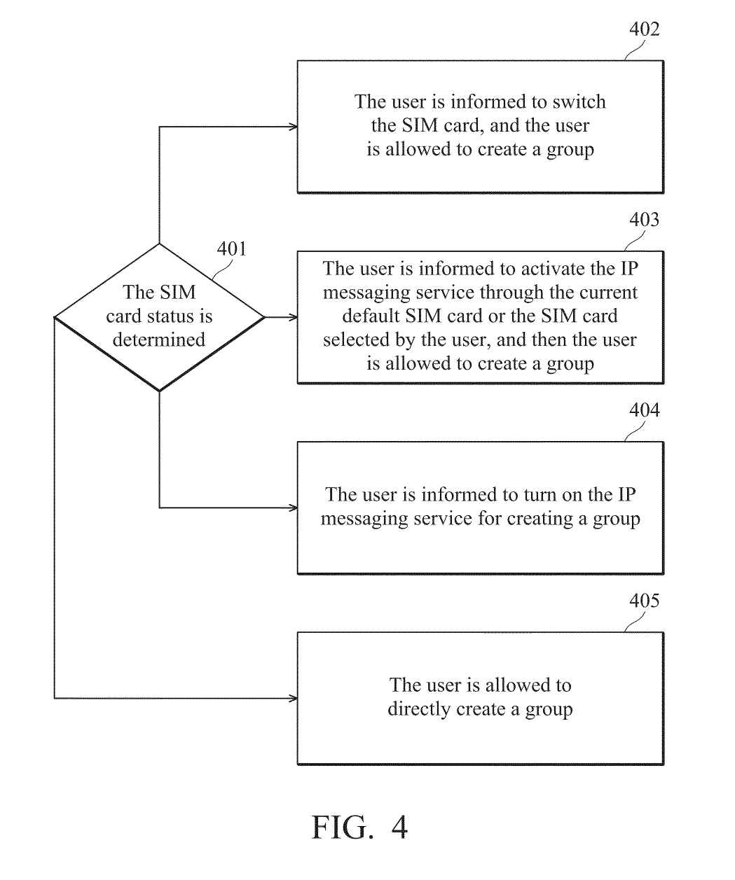

In one embodiment of the present invention, when the current default SIM card is not set (i.e., “Always ask” is set), a dialog box for selecting the SIM card is popped up to inform the user to select the SIM card. FIG. 4 is a flow diagram of determining a SIM card status to create a conversation group according to an embodiment of the invention. As shown in FIG. 4, when the user wants to create a new group, the SIM card status is determined (Step 401). In one embodiment, the status includes whether the IP messaging service is activated through the SIM card, whether the IP messaging service (the account) is turned on through the SIM card. Next, the way of creating a group is selected according to the determination result.

When it is determined that the IP messaging service is not activated through the current default SIM card or the SIM card selected by the user, but the IP messaging service is turned on through another SIM card, the user is informed to switch the SIM card, and then the user is allowed to create a group (Step 402).

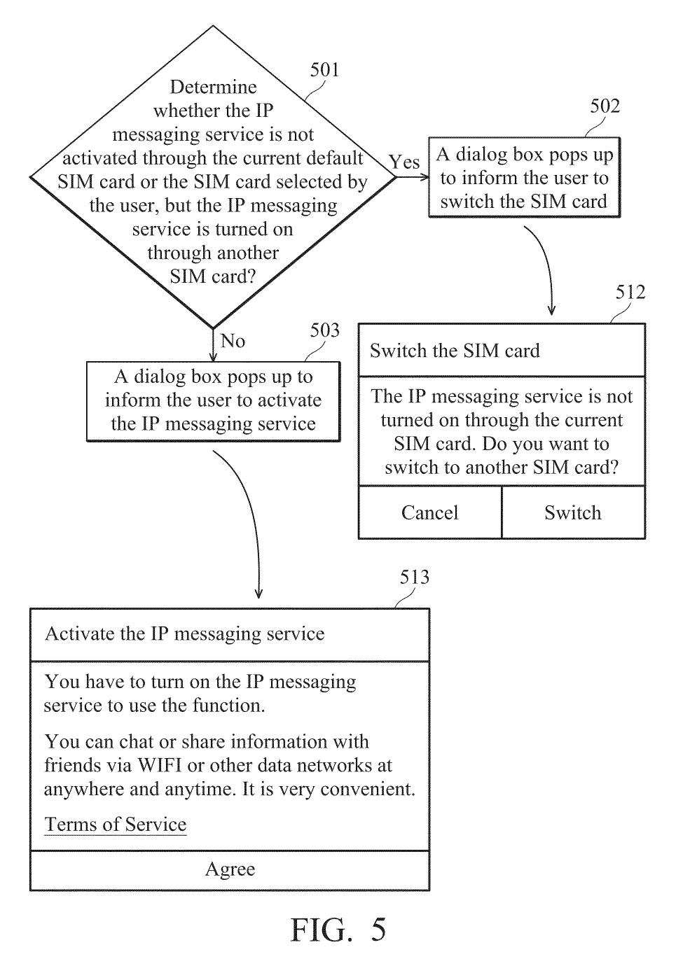

When it is determined that the IP messaging service is not activated through the current default SIM card or the SIM card selected by the user, and the IP messaging service is not turned on through another SIM card, the user is informed to activate the IP messaging service through the current default SIM card or the SIM card selected by the user, and then the user is allowed to create a group (Step 403). FIG. 5 is a flow diagram of informing a user to switch a SIM card and activate the IP messaging service according to an embodiment of the invention. As shown in FIG. 5, it is determined whether the IP messaging service is not activated through the current default SIM card or the SIM card selected by the user, but the IP messaging service is turned on through another SIM card (Step 501). If yes, a dialog box 512 pops up to inform the user to switch the SIM card (step S502). When it is determined the IP messaging service is not activated through the current default SIM card or the SIM card selected by the user, and the IP messaging service is not turned on through another SIM card, a dialog box 513 pops up to inform the user to activate the IP messaging service through the current default SIM card or the SIM card selected by the user (step S503). It should be noted that FIG. 5 is merely illustrative, and the present invention is not limited to using the dialog boxes shown in FIG. 5.

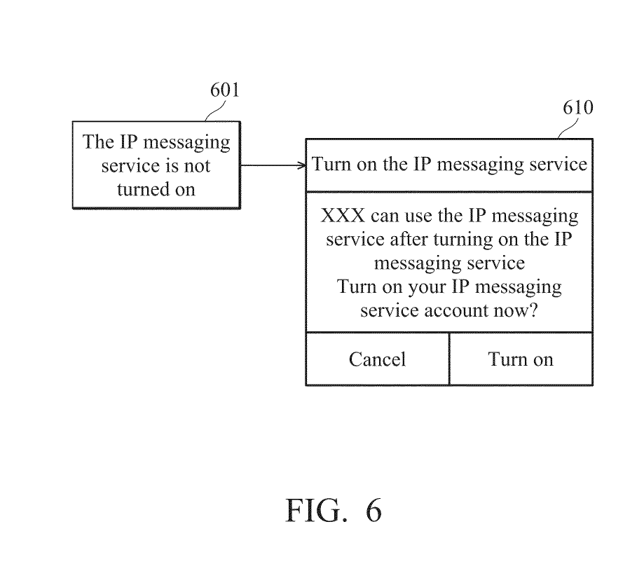

When it is determined that the IP messaging service is activated through the current default SIM card or the SIM card selected by the user, but the IP messaging service is not turned on, the user is informed to turn on the IP messaging service for creating a group (Step 404). FIG. 6 is a flow diagram of informing a user to turn on the IP messaging service according to an embodiment of the invention. In one embodiment, a dialog box can be used to inform the user. As shown in FIG. 6, it is determined that the IP messaging service is activated through the current default SIM card or the SIM card selected by the user, but the IP messaging service is not turned on (Step 601), a dialog box 610 is popped up to inform the user to turn on the IP messaging service. It should be noted that FIG. 6 is merely illustrative, and the present invention is not limited to using the dialog boxes shown in FIG. 6.

When it is determined that the IP messaging service is turned on through the current default SIM card or the SIM card selected by the user, the user is allowed to directly create a group (Step 405).

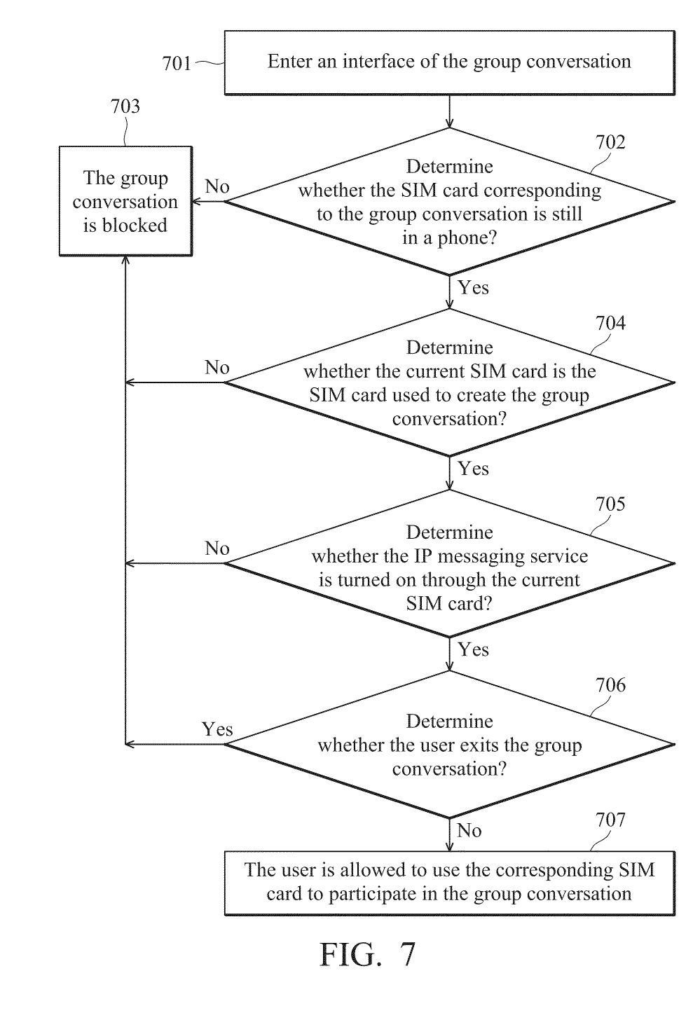

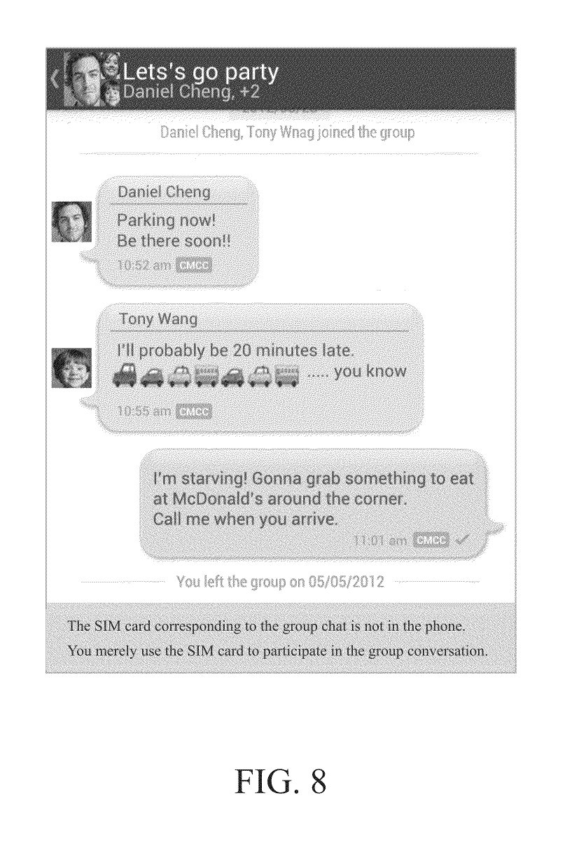

Due to special features of the multi-card phone, in one embodiment of the present invention, as soon as a user involves in the group chat after the group is created, the SIM card corresponding to the group will be determined. The user is not allowed to use two SIM cards to participate in the group. When the user exits the group or changes the SIM card, the user can further consider whether to join the group. FIG. 7 is a flow diagram of determining whether a user can join a group conversation according to an embodiment of the invention. As shown in FIG. 7, the user enters an interface of the group conversation (Step 701), such as from a list of conversations into the interface of the group conversation. It is determined whether the SIM card corresponding to the group conversation is still in a phone (Step 702). When the SIM card is not in the phone, for example, the corresponding SIM card has been taken out from the mobile phone, the group conversation is blocked (Step 703). In one embodiment, a color (e.g., gray) area is used to cover an input block of the group conversation. In another embodiment, the user is further informed that the group conversation is unavailable. FIG. 8 is a flow diagram of informing the user that the group conversation is unavailable according to an embodiment of the invention. As shown in FIG. 8, a text is used to inform the user that the SIM card corresponding to the group conversation does not exist, and only the corresponding SIM card can be used to participate in the group conversation. It should be noted that FIG. 8 is merely illustrative, and the present invention is not limited to using the text shown in FIG. 8.

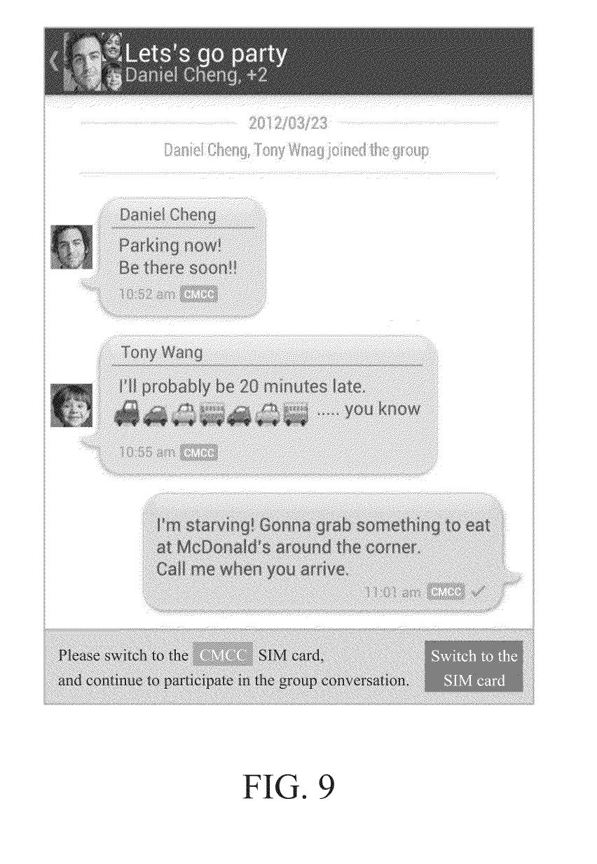

When the SIM card corresponding to the group conversation is in the phone, it is further determined whether the current SIM card (account) is the SIM card (account) used to create (participate) the group conversation (Step 704). If not, the group conversation is blocked (Step 703). In one embodiment, a color (e.g., gray) area is used to cover an input block of the group conversation. In another embodiment, the user is further informed to switch to the SIM card corresponding to the group conversation (such as the SIM card or the account which is used to create or participate in the group conversation). In yet another embodiment, a fast switch may be further provided for the user to switch the SIM card (account), as shown in FIG. 9. FIG. 9 is a schematic diagram of informing the user to switch the SIM card according to an embodiment of the invention. It should be noted that FIG. 9 is merely illustrative, and the present invention is not limited to using the text shown in FIG. 9.

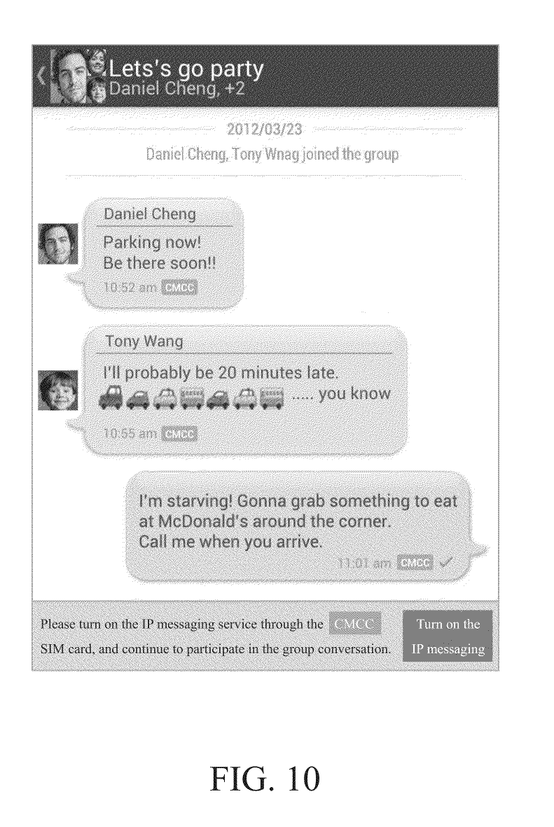

When the current SIM card (account) is the SIM card (account) used to create (participate) the group conversation, it is further determined whether the IP messaging service is turned on through the current SIM card (account) (Step 705). When the IP messaging service is not turned on, the group conversation is blocked (Step 703). In one embodiment, a color (e.g., gray) area is used to cover an input block of the group conversation. In another embodiment, the user is further informed to turn on the IP messaging service. In yet another embodiment, a fast switch may be further provided the user to turn on the IP messaging service, as shown in FIG. 10. FIG. 10 is a schematic diagram of informing the user to turn on the IP messaging service according to an embodiment of the invention. It should be noted that FIG. 10 is merely illustrative, and the present invention is not limited to using the text shown in FIG. 10.

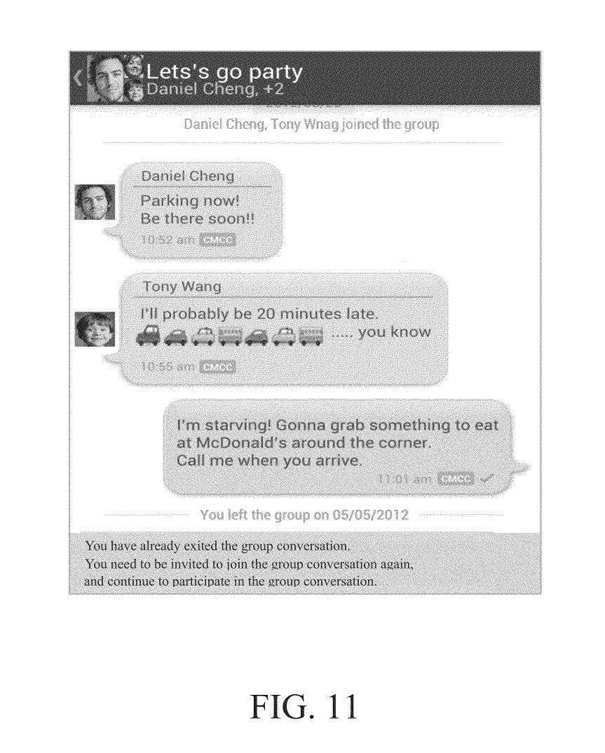

When the IP messaging service has been turned on through the current SIM card (account), it is further determined whether the user exits the group conversation (Step 706). When the user does not exit the group conversation, the user is allowed to use the corresponding SIM card to participate in the group conversation (Step 707). When the user exits the group conversation, the group conversation is blocked (Step 703). In one embodiment, a color (e.g., gray) area is used to cover an input block of the group conversation. In another embodiment, the user is further informed to participate in the group conversation again. In yet another embodiment, a text can used to inform the user that the user has already exited the group conversation. The user needs to be invited to join the group conversation again when the user wants to continue the group conversation, as shown in FIG. 11. FIG. 11 is a schematic diagram of informing the user to join the group conversation again according to an embodiment of the invention. It should be noted that FIG. 11 is merely illustrative, and the present invention is not limited to using the text shown in FIG. 11. In the present invention, the function of the IP messaging can be added into the group conversation, and the IP messaging can be combined with the group conversations corresponding to the multi-card mobile phone. It is convenient for the user to use the group conversations and further helpful to save on phone fees.

As may be appreciated by those skilled in the art, using the IP messaging can save more money than using the SMS/MMS message. Therefore, in one embodiment of the present invention, a “reminder mechanism” is set to encourage the user to use the IP messaging and send the message by choosing the most reasonable way. The “reminder mechanism” means that the inform message used to inform the user is sent according to a predefined rules based on the SIM cards (accounts) status of the user and the person that the user talks to and the type of the message to be sent. In one embodiment, an inform message can be popped up at the top of the conversation page to inform the user. In another embodiment, the inform message will be sent when at least one of the two following conditions is satisfied: more than N messages are transmitted in one day, or the user has chatted with the same person for over M consecutive days, wherein N and M are positive integers which can be set by those skilled in the art according to design requirements. In another embodiment, the inform message is not displayed in case where the user manually turns off the function of the inform message.

According to the predefined rules, when the usage statuses of the IP messaging services between the user and other people that the user talks to are different, the inform messages are different. There are four statuses that may be described as follows:

1) When the user has an active IP messaging account and uses the account to talk to a person who activates the IP messaging service, the inform message is not displayed.

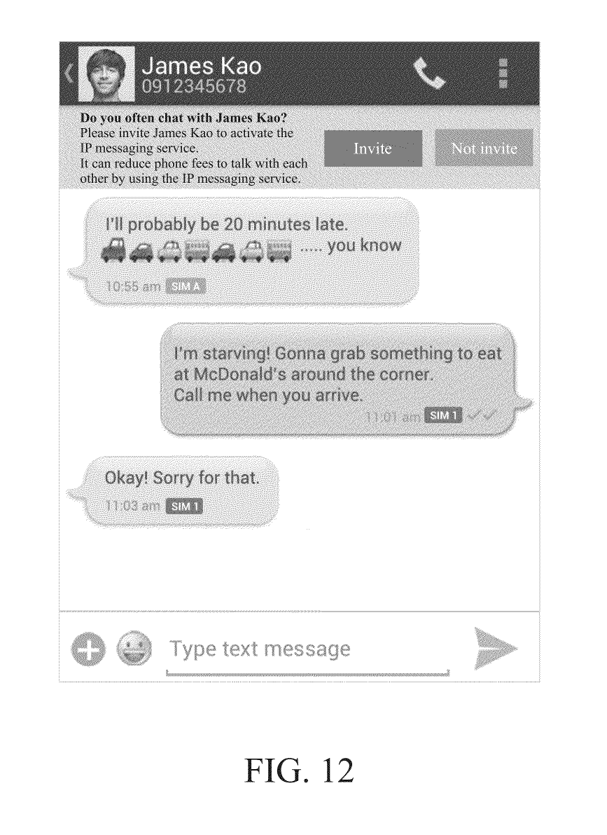

2) When the user has an active IP messaging account and uses the account to talk to a person who does not activate the IP messaging service, an inform message showing that the user can invite the person to activate the IP messaging service is displayed. FIG. 12 is a schematic diagram of the inform message illustrating that the user invites the person to activate the IP messaging service according to an embodiment of the invention. As shown in FIG. 12, the inform message at the top of the conversation page shows that the user can invite the person to activate the IP messaging service. It can reduce phone fees to talk with each other by using the IP messaging service. It should be noted that FIG. 12 is merely illustrative, and the present invention is not limited to using the inform message shown in FIG. 12.

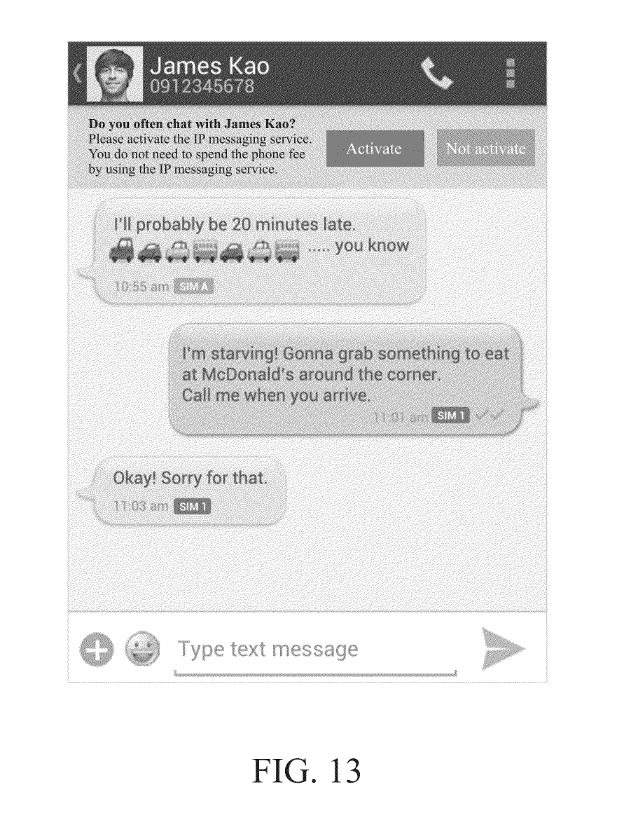

3) When the user does not activate the IP messaging account and often uses the account to talk to a person who has activated the IP messaging service, the inform message showing that the user can activate the IP messaging service is displayed. FIG. 13 is a schematic diagram of the inform message illustrating that the user can activate the IP messaging service according to an embodiment of the invention. As shown in FIG. 13, the inform message at the top of the conversation page shows that the user can activate the IP messaging service, and the user does not need to spend the phone fee. It should be noted that FIG. 13 is merely illustrative, and the present invention is not limited to using the inform message shown in FIG. 13.

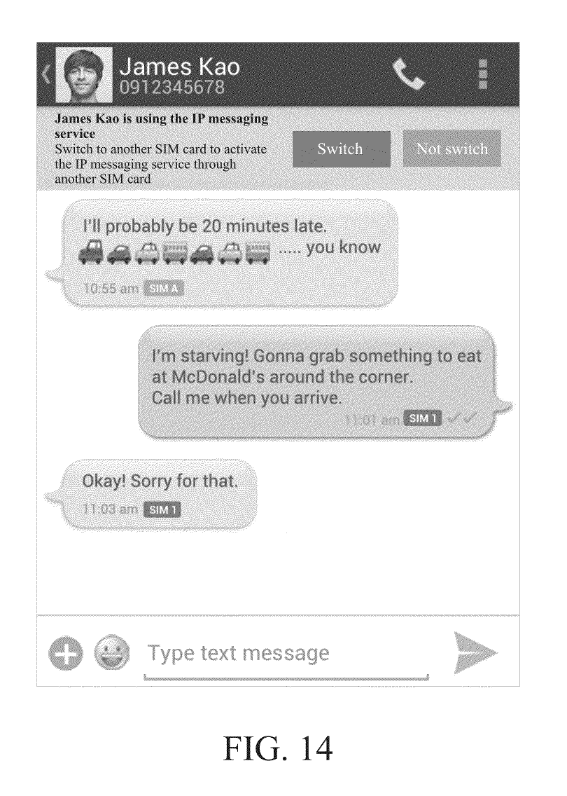

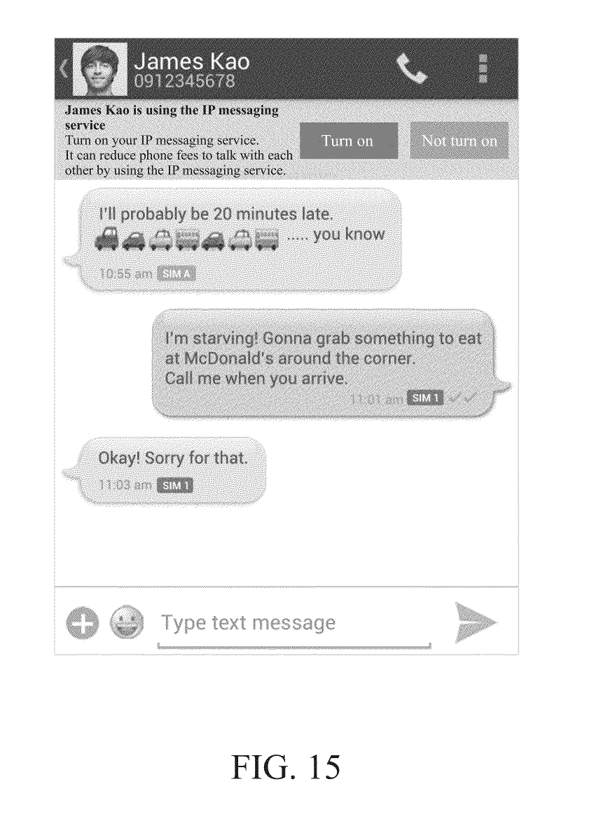

4) When the user has an active IP messaging account, and the user uses another account (another SIM card) to talk to a person who has activated the IP messaging service, the inform message showing that the user can switch to another SIM card (account) is displayed. FIG. 14 is a schematic diagram of the inform message illustrating that the user can switch to another SIM card according to an embodiment of the invention. As shown in FIG. 14, the inform message at the top of the conversation page shows that the person who the user talks to uses the IP messaging service, and whether the user wants to switch to another SIM card to activate the IP messaging service through another SIM card. It should be noted that FIG. 14 is merely illustrative, and the present invention is not limited to using the inform message shown in FIG. 14. When the user closes the IP messaging service of the SIM card (account), and uses the SIM card (account) to talk to the person who has activated the IP messaging service, the inform message showing that the user can open the SIM card (account) is displayed. FIG. 15 is a schematic diagram of the inform message illustrating that the user can open the SIM card according to an embodiment of the invention. As shown in FIG. 15, the inform message at the top of the conversation page shows that the person who the user talks to uses the IP messaging service, and the user can turn on the IP messaging service for talking to the person to save on phone fees. It should be noted that FIG. 15 is merely illustrative, and the present invention is not limited to using the inform message shown in FIG. 15.

In one embodiment of the present invention, a clearer user interface is provided for convenient use by the user. An “Ignore” button can be set in the inform message. After the user selects the “Ignore” button, the user will not see any inform message again during a time period. When the usage statuses of the IP messaging services between the user and other people that the user talks to meet one of the four statuses described above after the time period, the corresponding inform message is displayed. The reminder mechanism proposed in the invention can avoid disturbing the user and enhance the accuracy of the inform message.

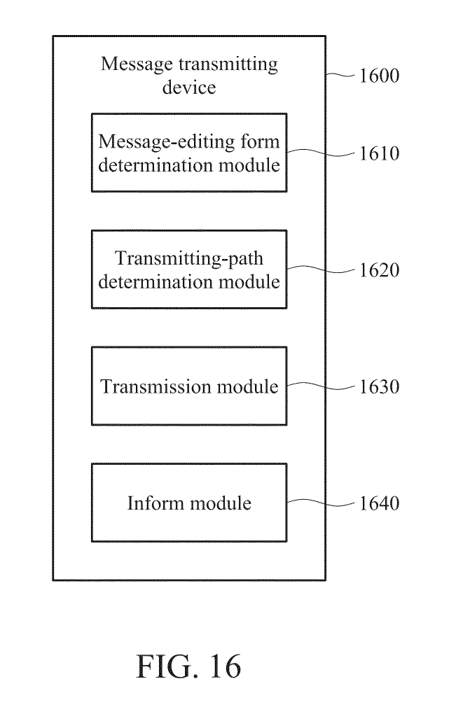

Next, referring to FIG. 16, FIG. 16 is a block diagram illustrating a message transmitting device 1600 according to an embodiment of the invention, wherein the message transmitting device can be used in a mobile device to determine the message transmitting ways of the mobile device. The mobile device may be, for example, a dual card mobile phone, a multi-card mobile phone, or other devices which are similar to the device described above. The message transmitting device 1600 includes a message-editing form determination module 1610, a transmitting-path determination module 1620, a transmission module 1630, an inform module 1640 which are used to perform the steps and the processes described in FIGS. 1 to 15, respectively. For example, the message-editing form determination module 1610 can determine a message-editing form according to a first determining condition of FIG. 1. The transmitting-path determination module 1620 can determine a path for transmitting the message according to a second determining condition of FIG. 2. The transmission module 1630 can transmit the message according to the path of FIG. 3. In addition, the transmitting-path determination module 1620 can determine whether to use a SIM card corresponding to the group conversation and/or turn on the IP messaging service. When it is determined to use the SIM card corresponding to the group conversation or turn on the IP information service, the transmission module 1630 transmits the message in the IP messaging form in the group conversation. When the transmitting-path determination module 1620 determines that the SIM card corresponding to the group conversation is not being used or the IP information service is not turned on, the inform module 1620 transmits an inform message shown in FIG. 9 to inform the user to switch the SIM card corresponding to the group conversation or turn on the IP messaging service for transmitting the message in the IP messaging form. In addition, the inform module 1640 can also transmit an inform message to inform the user to select a path for transmitting the message.

It is understood that the message-editing form determination module 1610, the transmitting-path determination module 1620, the transmission module 1630 and the inform module 1640 could be implemented by hardware, firmware, processor executing software, or in a combination of the three.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

It will be apparent to those skilled in the art that various modifications and variations can be made in the invention. It is intended that the standard and examples be considered exemplary only, with a true scope of the disclosed embodiments being indicated by the following claims and their equivalents.

1. A message transmitting method used in a multi-card mobile device, comprising:
determining a message-editing form according to a first determining condition;
determining a path for transmitting the message according to a second determining condition; and
transmitting the message according to the path.

2. The message transmitting method as claimed in claim 1, wherein the first determining condition comprises a SIM card status of a sender and a SIM card status of a recipient.

3. The message transmitting method as claimed in claim 2, wherein the second determining condition comprises the SIM card status of the sender.

4. The message transmitting method as claimed in claim 3, wherein the SIM card status is whether the SIM card opens up an IP messaging service.

5. The message transmitting method as claimed in claim 4, further comprising:
when the SIM card of the sender and the SIM card of the recipient turn on the IP messaging service, the message is edited in an IP messaging form and transmitted in an IP messaging form by the SIM card of the sender.

6. The message transmitting method as claimed in claim 1, wherein the method is used in a multi-card mobile phone, and the message is transmitted by a SIM card of the multi-card mobile phone.

7. The message transmitting method as claimed in claim 5, further comprising:
entering a group conversation, and determining whether to use a SIM card corresponding to the group conversation and/or turn on the IP messaging service; and
transmitting the message in the IP messaging form in the group conversation when determining to use the SIM card corresponding to the group conversation and/or turn on the IP messaging service.

8. The message transmitting method as claimed in claim 7, further comprising:
transmitting an inform message to inform a user to switch the SIM card corresponding to the group conversation or turn on the IP messaging service for transmitting the message in the IP messaging form when determining that the SIM card corresponding to the group conversation is not being used and/or the IP messaging service is not turned on.

9. The message transmitting method as claimed in claim 4, further comprising:
transmitting an inform message to inform a user to select the path for transmitting the message.

10. The message transmitting method as claimed in claim 9, further comprising:
determining the inform message according to a condition of the IP messaging service usage by the sender and the recipient.

11. A message transmitting device, used in a multi-card mobile device, comprising:
a message-editing form determination module, determining a message-editing form according to a first determining condition;
a transmitting-path determination module, determining a path for transmitting the message according to a second determining condition; and
a transmission module, transmitting the message according to the path.

12. The message transmitting device as claimed in claim 11, wherein the first determining condition comprises a SIM card status of a sender and a SIM card status of a recipient.

13. The message transmitting device as claimed in claim 12, wherein the second determining condition comprises the SIM card status of the sender.

14. The message transmitting device as claimed in claim 13, wherein the SIM card status is whether the SIM card opens up an IP messaging service.

15. The message transmitting device as claimed in claim 14, wherein when the SIM card of the sender and the SIM card of the recipient open up the IP messaging service, the message is edited in an IP messaging form and the transmission module transmits the message in the IP messaging form by the SIM card of the sender.

16. The message transmitting device as claimed in claim 11, wherein the mobile device is a multi-card mobile phone.

17. The message transmitting device as claimed in claim 15, wherein when a user enters a group conversation, the transmitting-path determination module determines whether to use a SIM card corresponding to the group conversation and/or turn on the IP messaging service; and
the transmitting-path determination module transmits the message by using the IP messaging form in the group conversation when determining to use the SIM card corresponding to the group conversation and/or open up the IP messaging service.

18. The message transmitting device as claimed in claim 17, further comprising:
an inform module, transmitting an inform message to inform the user to switch the SIM card corresponding to the group conversation or turn on the IP messaging service for transmitting the message in the IP messaging form when the transmitting-path determination module determines that the SIM card corresponding to the group conversation is not being used and/or the IP messaging service is not turned on.

19. The message transmitting device as claimed in claim 14, further comprising:
an inform module, transmitting an inform message to inform a user to select the path for transmitting the message.

20. The message transmitting device as claimed in claim 19, wherein the inform module determines the inform message according to a condition of the IP messaging service usage by the sender and the recipient.
